(19) United States
(12) Patent Application Publication
(10) Pub. No.: US 2024/0416883 A1
(43) Pub. Date: Dec. 19, 2024

(54) Spring Applied, Hydraulically Released Service Brake System

(71) Applicant: Caterpillar Inc., Peoria, IL (US)

(72) Inventors: Shinya Sono, Naperville, IL (US); Benjamin J. Bargfrede, Chicago, IL (US); Mirko V. Barbir, Naperville, IL (US)

(73) Assignee: Caterpillar Inc., Peoria, IL (US)

(21) Appl. No.: 18/334,576

(22) Filed: Jun. 14, 2023

(51) Int. Cl. B60T 13/22

(52) U.S. Cl. CPC B60T 13/22

(57) ABSTRACT

A service brake system for a machine includes a brake assembly including a brake actuator and a brake spring. The brake actuator is movable in a brake application direction and in a brake disengagement direction. The brake spring is arranged to apply a spring force on the brake actuator in the brake application direction. The brake actuator has a first pressure chamber and a second pressure chamber. Pressurized fluid introduced into the first and second pressure chambers respectively applies a first and a second hydraulic force on the brake actuator in the brake disengagement direction counter to the spring force. A first pressurized fluid supply is in communication with the first pressure chamber for providing pressurized fluid to generate the first hydraulic force. A second pressurized fluid supply in communication with the second pressure chamber for providing pressurized fluid to generate the second hydraulic force.

### TECHNICAL FIELD

This patent disclosure relates generally to a machine having a spring applied, hydraulically released service brake system and, more particularly, to a spring applied, hydraulically released service brake system with modulated secondary braking.

### BACKGROUND

A mobile machine, such as a truck or wheel loader, used in an industrial setting such as construction, mining, forestry and the like utilizes braking systems for slowing and/or stopping the machine. To provide redundant braking capability, many such mobile machines have a secondary braking system. A secondary braking system is a braking system that operates even after a failure of the primary braking system, for example due to a hydraulic failure. Moreover, mobile machines that will exceed a certain ground speed, must have a secondary brake system that is modulated. In particular, ISO standards (ISO 3450:2011) require machines that exceed a speed of 20 km/hr to have a modulated secondary brake system. Modulated braking systems allow the operator to control the amount of deceleration of the machine. Mobile machines may be equipped with both service brakes and parking brakes. A parking brake could be configured to provide this modulated secondary braking. However, many parking brake systems are not modulated, that is they can only be fully engaged or disengaged.

A tandem split circuit system is a common arrangement for providing hydraulic primary and secondary brakes. A split circuit system includes two ports at the brake pedal that are separated by a tandem valve. Each port feeds an independent hydraulic brake circuit. For example, one brake circuit may control the rear brakes while the other brake circuit controls the front brakes. Under normal operation, when an operator applies the brake pedal, the tandem valve splits the braking equally between the two brake circuits. Because the two brake circuits are independent of each other, if one of the brake circuits fails due to, for example, a failure in the hydraulics, the other brake circuit can still operate. Thus, the two brake circuits operate as modulated secondary brake systems for each other. Machines equipped with a tandem split circuit system may also have a tertiary parking brake system. The parking brake is typically a system that can only operate in engaged and disengaged modes and thus is not modulated.

Most service brake systems are hydraulically applied, spring released systems. Hydraulically applied, spring released brake systems are configured such that hydraulic actuators apply the force that engages the brakes while a spring applies the force that disengages the brake. Thus, in operation, the hydraulic actuator applies a force counter to the spring to apply the brakes and as the hydraulic force is eased the spring releases the brakes. In contrast, many parking brake systems are spring applied, hydraulically released brake (SAHR) systems. With such systems, the hydraulic actuator holds the parking brake disengaged against the force of the spring. When a SAHR parking brake is applied, the hydraulic force from the actuator holding back the spring is removed and the spring force moves the brakes into engagement.

SAHR brake systems are generally considered inappropriate for a service brake system. In particular, a failure of the hydraulic system in a SAHR brake system will result in unintentional, unmodulated and/or auto application of the brakes because a drop in hydraulic pressure will eliminate the force necessary to counteract the spring force acting to engage the brakes. Such a failure mode also makes the SAHR brake system inappropriate for a secondary brake system because a single hydraulic failure could lead to the inability to provide modulated braking.

The need to provide a machine with separate service and secondary brake systems and a parking brake system has several disadvantages. For example, the separate brake systems can make the machine more costly to manufacture. The separate brake systems also add weight to the machine making the machine less efficient to operate. Moreover, the separate brake systems can add complexity to the machine which could lead to increased maintenance costs.

U.S. Pat. No. 8,820,857 (“the '857 patent”) describes a parking brake system configured to prevent unintended auto-application of the parking brake. More specifically, the '857 patent discloses a SAHR parking brake system that has independent hydraulic lines for each parking brake and at least one of the hydraulic lines includes a control valve that limits the flow of hydraulic fluid out of the system when the hydraulic line is damaged. The '857 patent, however, fails to appreciate the problems associated with designing service brake systems that have a modulated secondary brake system.

### SUMMARY

The disclosure describes, in one aspect, a service brake system for a machine including at least one brake assembly. The brake assembly includes a brake actuator and a brake spring. The brake actuator is movable in a brake application direction and in a brake disengagement direction opposite the brake application direction. The brake spring is arranged to apply a spring force on the brake actuator in the brake application direction. The brake actuator has a first pressure chamber and a second pressure chamber with the first and second pressure chambers being fluidly isolated from each other. The first and second pressure chambers are arranged such that pressurized fluid introduced into the first and second pressure chambers respectively applies a first and a second hydraulic force on the brake actuator in the brake disengagement direction counter to the spring force. A first pressurized fluid supply is in communication with the first pressure chamber for providing pressurized fluid to generate the first hydraulic force. A second pressurized fluid supply is in communication with the second pressure chamber for providing pressurized fluid to generate the second hydraulic force. The first pressurized fluid supply and the first pressure chamber and the second pressurized fluid supply and the second pressure chamber are configured such that each of the first and second hydraulic forces can offset the spring force and move the brake actuator to a disengaged position.

In another aspect, the disclosure describes a brake assembly for a service brake system. The brake assembly includes a brake actuator that is movable in a brake application direction and in a brake disengagement direction opposite the brake application direction. The brake actuator has a first pressure chamber and a second pressure chamber with the first and second pressure chambers being fluidly isolated from each other. A brake spring is arranged to apply a spring force on the brake actuator in the brake application direction. The first and second pressure chambers are arranged such that pressurized fluid introduced into the first and second pressure chambers respectively applies a first and a second hydraulic force on the brake actuator in the brake disengagement direction counter to the spring force.

In yet another aspect, the disclosure describes a mobile machine comprising a frame and at least one traction device supported on the machine frame. The machine includes a service brake system for a applying a braking force on the at least one traction device. The service brake system includes at least one brake assembly including a brake actuator and a brake spring. The brake actuator is movable in a brake application direction and in a brake disengagement direction opposite the brake application direction. The brake spring is arranged to apply a spring force on the brake actuator in the brake application direction. The brake actuator has a first pressure chamber and a second pressure chamber with the first and second pressure chambers being fluidly isolated from each other. The first and second pressure chambers are arranged such that pressurized fluid introduced into the first and second pressure chambers respectively applies a first and a second hydraulic force on the brake actuator in the brake disengagement direction counter to the spring force. A first pressurized fluid supply is in communication with the first pressure chamber for providing pressurized fluid to generate the first hydraulic force A second pressurized fluid supply is in communication with the second pressure chamber for providing pressurized fluid to generate the second hydraulic force. The first pressurized fluid supply and the first pressure chamber and the second pressurized fluid supply and the second pressure chamber are configured such that each of the first and second hydraulic forces can offset the spring force and move the brake actuator to a disengaged position

### BRIEF DESCRIPTION OF THE DRAWINGS

FIG. 1 is a side elevation view of an exemplary machine having a service brake system according to the present disclosure.

FIG. 2 is a schematic diagram of a SAHR service brake system for the machine of FIG. 1.

FIG. 3 is a schematic cross-sectional diagram of one SAHR brake assembly of the service brake system of FIG. 2.

FIG. 4 is a plot of service brake input device movement or force versus brake force for both the primary and secondary brakes of the service brake system of FIG. 2.

### DETAILED DESCRIPTION

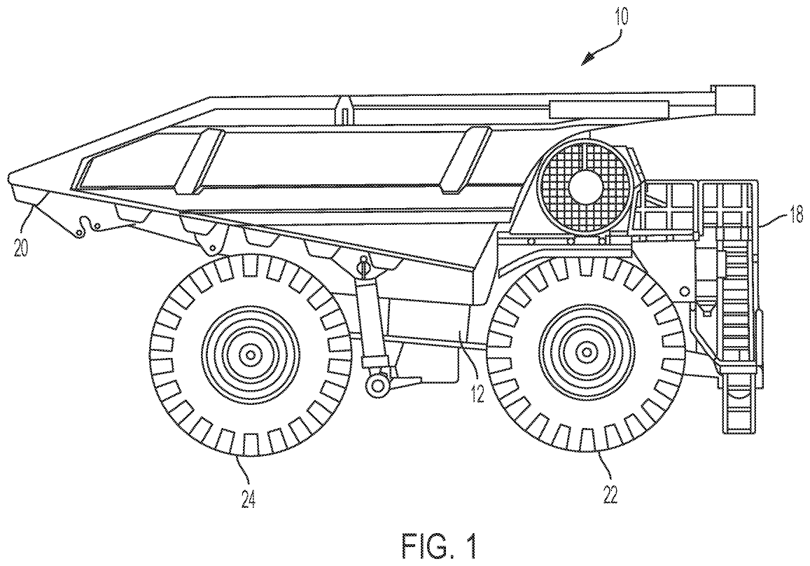

Now referring to the drawings, wherein whenever possible like reference numbers will refer to like elements, there is illustrated in FIG. 1 a mobile machine 10 in the particular embodiment of a truck that is configured to move about a work environment. However, while the present disclosure uses the example of a truck 10, aspects of the disclosure may be applicable to other types of mobile machines that perform some type of operation in association with an industry such as mining, construction, farming, transportation or the like. For example, the machine may be an articulated truck, an off-highway truck, a wheel loader, a motor grader or other material moving machine that is configured to move about a work environment.

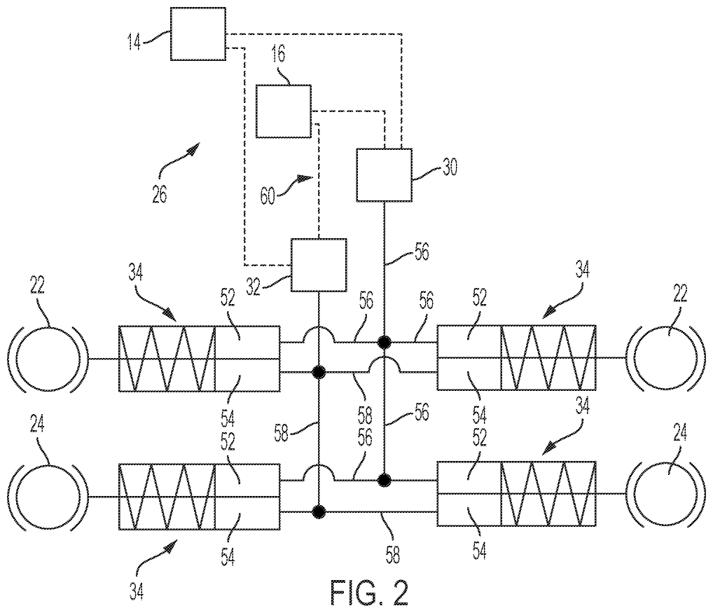

In the illustrated embodiment, the machine 10 includes a frame 12 on which various machine components may be supported. For example, a power source, such as an engine or battery systems, may be positioned within an enclosure supported on the frame 12. The power source may provide operational power to one or more machine components for operation thereof. The machine 10 also includes an operator cabin that may include various input and output devices for operating the machine. These devices may include an input device 14 (see FIG. 2), such as for example a foot pedal, for controlling application of a service brake system. Another input device 16 for directing application of a parking brake assembly may also be disposed in the operator cabin. For example, the parking brake input device 16 may be a foot or hand actuated device.

For facilitating movement, the machine 10 may include at least one traction device such as a wheel. In the illustrated embodiment, the machine 10 has a front end 18 and a rear end 20 with a pair of front wheels 22 arranged proximate the front end 18 of the machine 10 and a pair of rear wheels 24 arranged proximate the rear end 20 of the machine 10 (only one of each pair of wheels is depicted, as the other one of that pair lies further into the plane of the drawing sheet and so is obstructed by the depicted wheel). The front and rear wheels 22, 24 allow movement of the machine 10 on various surfaces. The front and rear wheels 22, 24 may be designated as powered drive wheels to propel the machine 10, steerable wheels to adjust direction of the machine 10, or combinations thereof. Other suitable embodiments of machines may include different traction devices such as continuous tracks that include a closed belt disposed about rollers and/or sprockets, whereby translation of the belt carries the machine over the work surface.

An exemplary service brake system 26 for the machine 10 is shown in FIG. 2. The service brake system 26 is a spring applied, hydraulically released (SAHR) brake system. For providing pressurized fluid (e.g., hydraulic fluid) for operation of the service brake system 26, the service brake system includes separate first and second pressurized fluid supplies 30, 32. Each of the first and second pressurized fluid supplies 30, 32 may be a respective hydraulic circuit that may include elements like a pump and fluid reservoir, a hydraulic fluid tank, one or more accumulators, hydraulic fluid lines, one or more control valves for directing the flow of hydraulic fluid in the service brake system 26 and one or more pressure sensors. The service brake input device 14, in this case, communicates with both of the first and second pressurized fluid supplies 30, 32 to direct application of the brakes as further described below. In the illustrated embodiment, the parking brake input device 16 also communicates with both the first and second pressurized fluid supplies 30, 32 to further provide a parking brake system as also described below.

As shown schematically in FIG. 2, the service brake system 26 may further include one or more brake assemblies 34 each being a SAHR brake assembly. In this case, a brake assembly 34 is provided at each of the two front wheels 22 and each of the two rear wheels 24 thus providing a pair of front brake assemblies 34 and a pair of rear brake assemblies 34. However, in other embodiments, a brake assembly 34 may be provided at only the front wheels 22 or only the back wheels 24. In this case, all of the brake assemblies 34 have the same configuration, but in other embodiments the individual brake assemblies may have different configurations in keeping with the present disclosure.

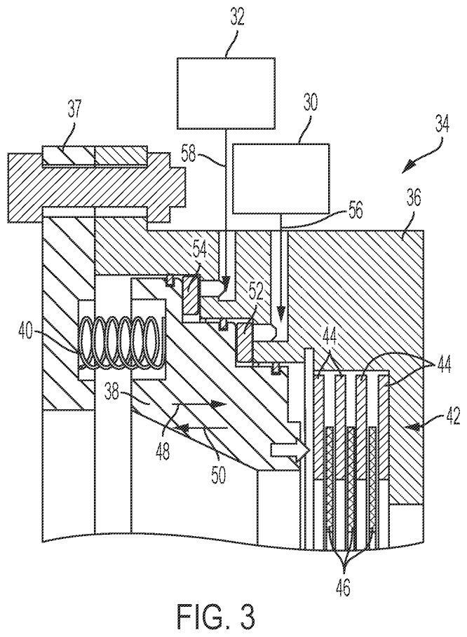

As shown in FIG. 3, each of the brake assemblies 34 includes a brake housing 36 with bolted on end plate 37 within which are supported a brake actuator 38, a brake spring 40, and a braking apparatus 42. In the illustrated embodiment, the braking apparatus 42 includes multiple brake plates 44 that can be brought into engagement with multiple brake discs 46. The brake plates 44 may be connected via, for example, a spline connection to the brake housing 36 while the brake discs 46 are connected to a rotating hub associated with a respective wheel 22, 24 via, for example, a spline connection. The connections of the brake plates 44 to the brake housing 36 and the brake discs 46 to the hub can also be accomplished using other methods such as, for example, dowels, tabs, etc. The brake actuator 38 is supported in the brake housing 36 for linear movement in a brake application direction (arrow 48 in FIG. 3) and in an opposite brake disengagement direction (arrow 50 in FIG. 3). Further, in keeping with the SAHR configuration, the spring 40 is supported in the housing 36 and confined by the end plate 37 so as to apply a spring force on the brake actuator 38 in the brake application direction 48. More particularly, movement of the brake actuator 38 in the brake application direction 48 causes the brake actuator 38 to apply a greater force on the braking apparatus 42 and a resultant increase of the braking force being applied to the respective wheel 22, 24. In this case, the increased force applied by the brake actuator 38 on the braking apparatus 42 results in an increase of a compression force applied by the brake plates 44 on the brake discs 46. In contrast, movement of the brake actuator 38 in the brake disengagement direction 50 causes the force applied by the brake actuator 38 on the braking apparatus 42 to lessen thereby decreasing the braking force applied to the respective wheel 22, 24. In this case, the lessening of the force applied by the brake actuator 38 on the braking apparatus 42 causes the compression force applied by the brake plates 44 on the brake discs 46 to lessen. When the brake actuator 38 is in a fully disengaged position, the braking force applied by the braking apparatus 42 is eliminated so that the machine 10 may move freely.

For applying a hydraulic force on the brake actuator 38 in the brake disengagement direction 50 counter to the spring force, the brake actuator 38 has a first pressure chamber 52 defining a first actuating area and a second pressure chamber 54 defining a second actuating area. In this case, the first and second pressure chambers 52, 54 are arranged on a side of the brake actuator 38 opposite the spring 40 as shown in FIG. 3. As shown in FIG. 2, the first pressure chamber 52 communicates with the first pressurized fluid supply 30 via a first fluid supply line 56 so as to be capable of applying a first fluid pressure on the first actuating area to produce a first hydraulic force. Similarly, the second pressure chamber 54 communicates with the second pressurized fluid supply 32 via a second fluid supply line 58 so as to be capable of applying a second fluid pressure on the second actuating area to produce a second hydraulic force. Moreover, the first and second pressure chambers 52, 54 are fluidly isolated from each other such that pressurized fluid introduced into one of the chambers cannot reach the other chamber.

The spring 40 is configured to provide a sufficient spring force on the brake actuator 38 to fully engage the braking apparatus 42 when an operator of the machine 10 calls for full braking via the service brake input device 14. Moreover, the first pressurized fluid supply 30 and the first pressure chamber 52 are configured to be capable of applying a first hydraulic force (defined by the first fluid pressure acting on the first actuating area) on the brake actuator 38 that results in full disengagement of the braking apparatus 42 when the operator of the machine 10 is not calling for any braking via the service brake input device 14. Likewise, the second pressurized fluid supply 32 and the second pressure chamber 54 are configured to be capable of applying a second hydraulic force (defined by the second fluid pressure acting on the second actuating area) on the brake actuator 38 that also results in full disengagement of the brakes when the operator is not calling for service braking. Thus, both the first pressurized fluid supply 30 and the first pressure chamber 52 and the second pressurized fluid supply 32 and the second pressure chamber 54 are configured to independently provide a hydraulic force on the braking actuator 38 sufficient to offset the spring force and move the brake actuator 38 to the fully disengaged position and thereby fully disengage the braking apparatus 42.

Additionally, the service brake input device 14 and the first and second pressurized fluid supplies 30, 32 are configured to allow an operator to adjust the first and second pressures (and thus the first and second hydraulic forces) so as adjust the level of braking produced by the brake assemblies 34. In this way, the braking force applied by the brake assemblies 34 may be modulated. In particular, when the operator calls for a level of braking less than full braking, the brake input device 14 directs the first and/or second pressurized fluid supplies 30, 32 to respectively introduce a first pressure in the first pressure chamber 52 and/or a second pressure in the second pressure chamber 54 that is less than the maximum first and second pressures that are achieved when the brake input device 14 is fully released (i.e., not depressed in the case of a foot pedal). These reduced first and second pressures only partially overcome the spring force allowing the spring 40 to still cause the brake actuator 38 to at least partially compress the brake plates 44 onto the brake discs 46 of the braking apparatus 42 and thereby provide a level of braking less than the full braking force capability of the brake assembly 34.

As noted, the illustrated machine 10 further includes a parking brake system 60 that includes a parking brake input device 16. In this case, the first and second pressurized fluid supplies 30, 32 are configured to provide full engagement of the brake assemblies 34 upon direction from the parking brake input device 16 to apply the parking brakes. As the brake assemblies 34 are SAHR brake assemblies, to apply the parking brakes, the first and second pressurized fluid supplies 32, 34 are directed to lower the first and second pressures in the first and second pressure chambers 52, 54 to the level at which the spring 40 is able to fully engage the brakes. The parking brake system 60 need not be modulated. In other words, the parking brake system 60 may be configured to only either fully engage or fully disengage the brake assemblies 34. Parking brake systems that utilize separate pressurized fluid supplies and/or separate brake assemblies from those used by the service brake system may alternatively be provided.

### INDUSTRIAL APPLICABILITY

The present disclosure is applicable to any type of mobile machine that requires braking capability. The present disclosure is particularly applicable to mobile machines that are subject to ISO standards (e.g., ISO 3450: 2011) that require modulated secondary braking systems. The service brake system 26 of the present disclosure has built in redundancy via the first and second pressurized fluid supplies 30, 32 and the first and second pressure chambers 52, 54 of the brake actuator 38. Each of the first and second pressurized fluid supplies 30, 32 communicating respectively with the first and second pressure chambers 52, 54 are independently capable of providing full modulated braking by varying the hydraulic force offsetting the spring force. In other words, together the first and second pressurized fluid supplies 30, 32 and their associated first and second pressure chambers 52, 54 provide primary braking while individually they can provide secondary braking. Thus, if one of the first and second pressurized fluid supplies 30, 32 fails, the other can still provide modulated secondary braking as required by the ISO standards.

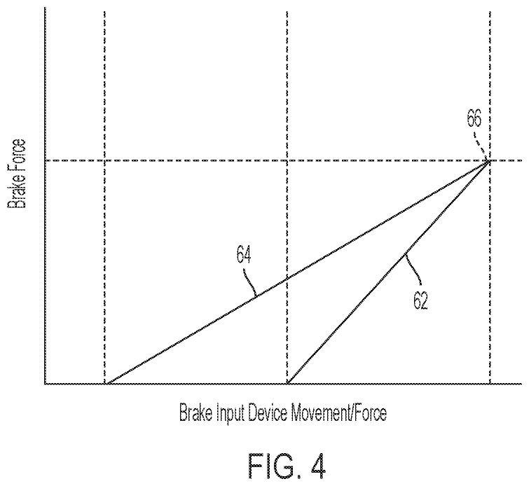

A further advantage of the service brake system 26 of the present disclosure is that both the primary and secondary braking systems are capable of providing the same maximum braking force because the brake assemblies 34 are spring applied and hydraulically released. With a SAHR brake assembly, the spring force is what actuates the brakes, while the hydraulic force is what releases the brakes. Since the spring force does not depend on operation of the first or second pressurized fluid supplies 30, 32, the spring force will be the same regardless of whether the first or second pressurized fluid supply 30, 32 is not operating. This is illustrated in the graph presented as FIG. 4. In FIG. 4, movement or force applied to the brake input device 14 (e.g., brake pedal rotation) is plotted on the x-axis and brake force is plotted on the y-axis. Line 62 represents the input device movement versus brake force for the primary brake system (in which both of the pressurized fluid supplies are operating) and line 64 represents the input device movement versus brake force for the secondary brake system. As can be seen, the primary and secondary braking systems both can reach the same maximum braking force 66 (as defined by the spring force). The only difference between the primary and secondary braking systems is that the secondary braking system requires less brake input device movement to reach a desired braking force because it presumes that only one of the pressurized fluid supplies is operating. The plot shown in FIG. 4 is one example for a spring having an almost linear force versus deflection curve. Depending on the desired modulation characteristics, spring designs having a non-linear spring force versus deflection curve can be considered.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or “one or more of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A service brake system for a machine comprising:
at least one brake assembly including a brake actuator and a brake spring, the brake actuator being movable in a brake application direction and in a brake disengagement direction opposite the brake application direction, the brake spring being arranged to apply a spring force on the brake actuator in the brake application direction, the brake actuator having a first pressure chamber and a second pressure chamber with the first and second pressure chambers being fluidly isolated from each other, the first and second pressure chambers being arranged such that pressurized fluid introduced into the first and second pressure chambers respectively applies a first and a second hydraulic force on the brake actuator in the brake disengagement direction counter to the spring force;
a first pressurized fluid supply in communication with the first pressure chamber for providing pressurized fluid to generate the first hydraulic force;
a second pressurized fluid supply in communication with the second pressure chamber for providing pressurized fluid to generate the second hydraulic force;
wherein the first pressurized fluid supply and the first pressure chamber and the second pressurized fluid supply and the second pressure chamber are configured such that each of the first and second hydraulic forces can offset the spring force and move the brake actuator to a disengaged position.

2. The service brake system of claim 1 wherein the first hydraulic force is variable by the first pressurized fluid supply and the second hydraulic force is variable by the second pressurized fluid supply.

3. The service brake system of claim 2 further comprising a service brake input device that controls the first and second pressurized fluid supplies to vary the first and second hydraulic forces.

4. The service brake system of claim 1 wherein the first pressurized fluid supply communicates with the first pressure chamber via a first fluid supply line and the second pressurized fluid supply communicates with the second pressure chamber via a second supply line.

5. The service brake system of claim 1 wherein the brake actuator engages with a braking apparatus that is configured to apply a braking force.

6. The service brake system of claim 5 wherein the braking apparatus includes multiple brake plates arranged to compress multiple brake discs.

7. The service brake system of claim 6 wherein the brake actuator is supported in a brake housing and is movable relative to the brake housing in the brake disengagement direction and the brake application direction.

8. The service brake system of claim 7 wherein the first and second pressure chambers are arranged on a side of the brake actuator opposite the spring.

9. A brake assembly for a service brake system, the brake assembly comprising:
a brake actuator that is movable in a brake application direction and in a brake disengagement direction opposite the brake application direction, the brake actuator having a first pressure chamber and a second pressure chamber with the first and second pressure chambers being fluidly isolated from each other; and
a brake spring arranged to apply a spring force on the brake actuator in the brake application direction;
wherein the first and second pressure chambers are arranged such that pressurized fluid introduced into the first and second pressure chambers respectively applies a first and a second hydraulic force on the brake actuator in the brake disengagement direction counter to the spring force.

10. The brake assembly of claim 9 wherein the brake actuator is supported in a brake housing and is movable relative to the brake housing in the brake disengagement direction and the brake application direction.

11. The brake assembly of claim 10 wherein the first and second pressure chambers are arranged on a side of the brake actuator opposite the spring.

12. The brake assembly of claim 9 wherein the brake actuator engages with a braking apparatus that is configured to apply a braking force.

13. The brake assembly of claim 12 wherein the braking apparatus includes multiple brake plates arranged to compress multiple brake discs.

14. A mobile machine comprising:
a frame;
at least one traction device supported on the machine frame;
a service brake system for a applying a braking force on the at least one traction device, the service brake system comprising:
at least one brake assembly including a brake actuator and a brake spring, the brake actuator being movable in a brake application direction and in a brake disengagement direction opposite the brake application direction, the brake spring being arranged to apply a spring force on the brake actuator in the brake application direction, the brake actuator having a first pressure chamber and a second pressure chamber with the first and second pressure chambers being fluidly isolated from each other, the first and second pressure chambers being arranged such that pressurized fluid introduced into the first and second pressure chambers respectively applies a first and a second hydraulic force on the brake actuator in the brake disengagement direction counter to the spring force;
a first pressurized fluid supply in communication with the first pressure chamber for providing pressurized fluid to generate the first hydraulic force;
a second pressurized fluid supply in communication with the second pressure chamber for providing pressurized fluid to generate the second hydraulic force;
wherein the first pressurized fluid supply and the first pressure chamber and the second pressurized fluid supply and the second pressure chamber are configured such that each of the first and second hydraulic forces can offset the spring force and move the brake actuator to a disengaged position.

15. The mobile machine of claim 14 wherein the first hydraulic force is variable by the first pressurized fluid supply and the second hydraulic force is variable by the second pressurized fluid supply.

16. The mobile machine of claim 15 further comprising a service brake input device that controls the first and second pressurized fluid supplies to vary the first and second hydraulic forces.

17. The mobile machine of claim 14 wherein the brake actuator engages with a braking apparatus that is configured to apply a braking force to the at least one traction element.

18. The mobile machine of claim 17 wherein the braking apparatus includes multiple brake plates arranged to compress multiple brake discs that are connected to the at least one traction element.

19. The mobile machine of claim 14 further comprising a parking brake system that includes a parking brake input device that directs the first and second pressurized fluid supplies.

20. The mobile machine of claim 14 wherein the first and second pressure chambers are arranged on a side of the brake actuator opposite the spring.
